(19) United States
(12) Patent Application Publication
(10) Pub. No.: US 2026/0025661 A1
(43) Pub. Date: Jan. 22, 2026

(54) METHOD AND DEVICE FOR ACCESSING USER EQUIPMENT TO MOBILE NETWORK

(71) Applicant: Beijing Xiaomi Mobile Software Co., Ltd., Beijing (CN)

(72) Inventors: Yang SHEN, Beijing (CN); Yuxin MAO, Beijing (CN)

(21) Appl. No.: 18/998,054

(22) PCT Filed: Aug. 2, 2022
(86) PCT No.: PCT/CN2022/109811

§ 371 Date: Jan. 23, 2025

(51) Int. Cl. H04W 12/08; H04L 9/40; H04W 8/22; H04W 12/06; H04W 60/04; H04W 84/04

(52) U.S. Cl. CPC H04W 12/08; H04L 63/0485; H04W 8/22; H04W 12/06; H04W 60/04; H04W 84/042

(57) ABSTRACT

A method for accessing a user equipment to a mobile network, including: accessing the user equipment to the mobile network through an untrusted or trusted non-3rd generation partnership project (3GPP) access network; where the user equipment is a satellite terminal that does not support new radio (NR), and the user equipment has satellite access and non-access stratum (NAS) capabilities.

### CROSS-REFERENCE

The present application is a U.S. National Stage of International Application No. PCT/CN2022/109811, filed on Aug. 2, 2022, the contents of which are incorporated herein by reference in their entirety for all purposes.

### BACKGROUND OF THE INVENTION

A satellite is a space-borne vehicle carrying a bent pipe payload or a regenerative payload telecommunications transmitter, usually placed on a low earth orbit (LEO) at altitudes of 300 km to 2000 km and on a medium earth orbit (MEO) at altitudes of 8000 km to 20000 km, or placed on a geostationary earth orbit (GEO) at altitude of 35786 km.

In an existing satellite access solution defined by 3rd generation partnership project (3GPP), a satellite next generation radio access network (NG-RAN) is an NG-RAN that provides satellite access to a user equipment (UE) using new radio (NR). The UE is ought to support the NR accessing the 3GPP network via satellite.

### SUMMARY OF THE INVENTION

The present disclosure relates to the technical field of communications, and in particular, to a method and device for accessing a user equipment to a mobile network.

In a first aspect, an embodiment of the present disclosure provides a method for accessing a user equipment to a mobile network. The method is performed by the user equipment, including:
accessing the user equipment to the mobile network through an untrusted or trusted non-3rd generation partnership project (3GPP) access network;
where the user equipment is a satellite terminal that does not support new radio (NR), and the user equipment has satellite access and non-access stratum (NAS) capabilities.

In a second aspect, an embodiment of the present disclosure provides another method for accessing a user equipment to a mobile network. The method is performed by an access and mobility management function (AMF), including:
accessing, by authenticating a user equipment connected to an untrusted non-3rd generation partnership project (3GPP) access network, the user equipment to the mobile network through a non-3GPP interworking function (N3IWF); or
accessing, by authenticating a user equipment connected to a trusted non-3GPP access network, the user equipment to the mobile network;
where the user equipment is a satellite terminal that does not support new radio (NR), and the user equipment has satellite access and non-access stratum (NAS) capabilities.

In a third aspect, an embodiment of the present disclosure provides another method for accessing a user equipment to a mobile network. The method is performed by a trusted non-3rd generation partnership project (3GPP) access network, including:
accessing a user equipment connected to the trusted non-3GPP access network to the mobile network;
where the user equipment is a satellite terminal that does not support new radio (NR), and the user equipment has satellite access and non-access stratum (NAS) capabilities.

In a fourth aspect, an embodiment of the present disclosure provides an electronic device. The electronic device includes: one or more processors; and a memory that stores processor-executable instructions, where the one or more processors are collectively configured to execute the processor-executable instructions to cause the electronic device to act as a user equipment and perform the method according to the above-mentioned first aspect.

In a fifth aspect, an embodiment of the present disclosure provides a non-transitory computer-readable storage medium storing instructions used by the above-mentioned user equipment; the instructions, when executed, causing the user equipment to perform the method according to the above-mentioned first aspect.

### BRIEF DESCRIPTION OF DRAWINGS

To more clearly illustrate the technical solutions in the embodiments of the present disclosure or the background art, the accompanying drawings needed to be used in the embodiments of the present disclosure or the background art will be explained below.

FIG. 1 is a schematic diagram of an architecture of a system for accessing a satellite terminal to a mobile network, provided by an embodiment of the present disclosure;

FIG. 2 is a schematic diagram of an architecture of another system for accessing a satellite terminal to a mobile network, provided by an embodiment of the present disclosure;

FIG. 3 is a schematic flowchart of a method for accessing a user equipment to a mobile network, provided by an embodiment of the present disclosure;

FIG. 4 is a schematic flowchart of another method for accessing a user equipment to a mobile network, provided by an embodiment of the present disclosure;

FIG. 5 is a schematic flowchart of registering through an untrusted non-3GPP access network, provided by an embodiment of the present disclosure;

FIG. 6 is a schematic flowchart of another method for accessing a user equipment to a mobile network, provided by an embodiment of the present disclosure;

FIG. 7 is a schematic flowchart of registering through a trusted non-3GPP access network, provided by an embodiment of the present disclosure;

FIG. 8 is a flowchart of yet another method for accessing a user equipment to a mobile network, provided by an embodiment of the present disclosure;

FIG. 9 is a flowchart of yet another method for accessing a user equipment to a mobile network, provided by an embodiment of the present disclosure;

FIG. 10 is a flowchart of yet another method for accessing a user equipment to a mobile network, provided by an embodiment of the present disclosure;

FIG. 11 is a flowchart of yet another method for accessing a user equipment to a mobile network, provided by an embodiment of the present disclosure;

FIG. 12 is a schematic structural diagram of a device for accessing a user equipment to a mobile network, provided by an embodiment of the present disclosure;

FIG. 13 is a schematic structural diagram of another device for accessing a user equipment to a mobile network, provided by an embodiment of the present disclosure.

### DETAILED DESCRIPTION OF THE INVENTION

Embodiments of the present disclosure will be described in detail below, examples of which are illustrated in the accompanying drawings, where throughout the same or similar reference numerals denote the same or similar elements or elements having the same or similar functions. The following embodiments described with reference to the accompanying drawings are illustrative and serve to explain the present disclosure, and are not to be construed as limiting the present disclosure. In the description of the present disclosure, “/” means “or” unless otherwise specified. For example, A/B may represent A or B; “and/or” herein is merely an association relationship describing associated objects, and indicates that three relationships may exist. For example, A and/or B may represent the following three cases: A exists alone, both A and B exist, and B exists alone.

A satellite is a space-borne vehicle carrying a bent pipe payload or a regenerative payload telecommunications transmitter, usually placed on low earth orbit (LEO) at altitudes of 300 km to 2000 km and on medium earth orbit (MEO) at altitudes of 8000 km to 20000 km, or placed on geostationary earth orbit (GEO) at altitude of 35786 km.

In an existing satellite access solution defined by 3GPP (3rd generation partnership project), a satellite NG-RAN (next generation radio access network) is an NG-RAN that provides satellite access to a UE (user equipment) using NR (new radio). The UE is ought to support the NR to access the 3GPP network via satellite.

There is a requirement in TS22.261 that a 5G (5th generation mobile communication technology) system with satellite access is ought to support different configurations, in which the radio access network is a satellite NG-RAN or a non-3GPP satellite access network, or both.

However, for a satellite terminal that does not support NR, there is currently no solution for a 3GPP network to serve the satellite terminal that does not support NR.

To solve the technical problem of how a mobile network serves a satellite terminal that does not support NR, the present disclosure has the following assumptions: 1) a user equipment (UE) has satellite access and NAS (Non Access Stratum) capabilities; and 2) for the UE accessing a 5GC (5G Core Network), there are two types of satellite access: trusted and untrusted, which are selected according to pre-configuring the combined information of the satellite access and the 5GC (such as PLMN (Public Land Mobile Network) ID (identifier)) in the UE.

In some examples, the present disclosure may access a satellite terminal that does not support NR to a mobile network through an untrusted or trusted non-3GPP access network. If the satellite access mode in which the user equipment accesses the 5G core network is different, the corresponding communication system architecture will also be different. Two communication systems will be presented below to respectively correspond to the untrusted satellite access mode and the trusted satellite access mode.

To better understand a method for accessing a user equipment to a mobile network disclosed in an embodiment of the present disclosure, a communication system to which the embodiment of the present disclosure is applicable will be described below first.

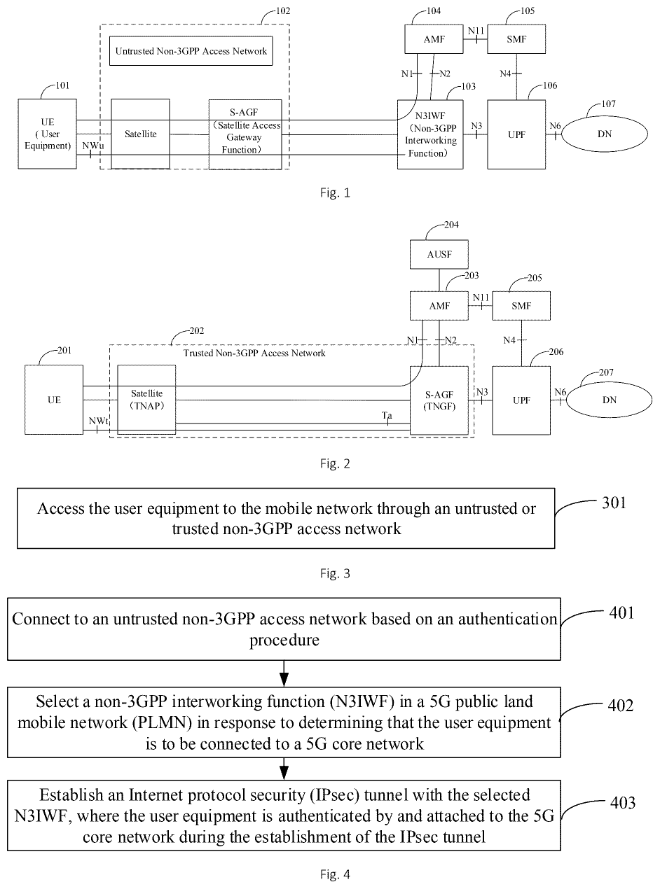

Reference is made to FIG. 1, which is a schematic diagram of an architecture of a system for accessing a satellite terminal to a mobile network, provided by an embodiment of the present disclosure. The system corresponds to an untrusted satellite access mode. The system may include, but is not limited to, one user equipment 101, one untrusted non-3GPP access network 102, one N3IWF (Non-3GPP Interworking Function) 103, one AMF (Access and Mobility Management Function) 104, one SMF (Session Management Function) 105, one UPF (User Plane Function) 106 and one DN (Data Network) 107. The number and form of the devices shown in FIG. 1 are merely for example and do not constitute limitation of the embodiments of the present disclosure. Included in actual applications may be two or more user equipments, two or more untrusted non-3GPP access networks, two or more N3IWFs, two or more AMFs, two or more SMFs, two or more UPFs, and two or more DNs. As an example, the system shown in FIG. 1 includes one network device 101, one untrusted non-3GPP access network 102, one N3IWF 103, one AMF 104, one SMF 105, one UPF 106 and one DN 107.

It is to be noted that the technical solutions of the embodiments of the present disclosure may be applied to various communication systems, for example, a 5th generation (5G) mobile communication system, a 5G new radio (NR) system, or other future new mobile communication systems, or the like.

The untrusted non-3GPP access network 102 in the embodiments of the present disclosure includes a satellite and an S-AGF (Satellite Access Gateway Function).

The user equipment 101 in an embodiment of the present disclosure is an entity for receiving or transmitting signals at the user side, such as a mobile phone. The user equipment 101 may also be referred to as an enhancing satellite terminal. The user equipment 101 may be a satellite terminal that does not support NR, and the user equipment 101 has satellite access and non-access stratum (NAS) capabilities. The user equipment 101 may be a vehicle with a communication function, a smart vehicle, a mobile phone, a wearable device, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless device in a smart home, and the like. The specific technology and specific device form adopted by the user equipment are not limited in the embodiments of the present disclosure.

It is to be noted that, in an embodiment of the present disclosure, there is an N1 interface between the user equipment 101 and the AMF 104. There is an NWu interface between the user equipment 101 and the N3IWF 103. There is an N2 interface between the N3IWF 103 and the AMF 104. There is an N3 interface between the N3IWF 103 and the UPF 106. There is an N11 interface between the AMF 104 and the SMF 105. There is an N4 interface between the SMF 105 and the UPF 106. There is an N6 interface between the UPF 106 and the DN 107.

Reference is made to FIG. 2, which is a schematic diagram of an architecture of another system for accessing a satellite terminal to a mobile network, provided by an embodiment of the present disclosure. The system corresponds to a trusted satellite access mode. The system may include, but is not limited to, one user equipment 201, one trusted non-3GPP access network 202, one AMF 203, one AUSF (Authentication Server Function) 204, one SMF 205, one UPF 206 and one DN 207. The number and form of the devices shown in FIG. 2 are merely for example and do not constitute limitation of the embodiments of the present disclosure. Included in actual applications may be two or more user equipments, two or more trusted non-3GPP access networks, two or more AMFs, two or more AUSFs, two or more SMFs, two or more UPFs and two or more DNs. As an example, the system shown in FIG. 2 includes one network device 201, one trusted non-3GPP access network 202, one AMF 203, one AUSF 204, one SMF 205, one UPF 206 and one DN 207.

It is to be noted that the technical solutions of the embodiments of the present disclosure may be applied to various communication systems, for example, a 5th generation (5G) mobile communication system, a 5G new radio (NR) system, or other future new mobile communication systems, or the like.

The trusted non-3GPP access network 202 in the embodiments of the present disclosure may include a trusted non-3GPP access point (TNAP) and a trusted non-3GPP gateway function (TNGF). The TNAP may be a satellite and the TNGF may be an S-AGF.

The user equipment 201 in an embodiment of the present disclosure is an entity for receiving or transmitting signals at the user side, such as a mobile phone. The user equipment 201 may also be referred to as an enhancing satellite terminal. The user equipment 201 may be a satellite terminal that does not support NR, and the user equipment 201 has satellite access and non-access stratum (NAS) capabilities. The user equipment 201 may be a vehicle with a communication function, a smart vehicle, a mobile phone, a wearable device, a Pad, a computer with a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless device in a smart home, and the like. The specific technology and specific device form adopted by the user equipment are not limited in the embodiments of the present disclosure.

It is to be noted that, in an embodiment of the present disclosure, there is an N1 interface between the user equipment 101 and the AMF 203. There is an NWu interface between the user equipment 201 and the TNGF. There is a Ta interface between the TNAP and the TNGF. There is an N2 interface between the TNGF and the AMF 203. There is an N11 interface between the AMF 203 and the SMF 205. There is an N4 interface between the SMF 205 and the UPF 206. There is an N6 interface between the UPF 206 and the DN 207.

It can be understood that the system for accessing a satellite terminal to a mobile network described in an embodiment of the present disclosure is intended to more clearly illustrate the technical solutions of the embodiment of the present disclosure, and does not constitute limitation of the technical solutions provided by the embodiment of the present disclosure. It can be known to those of ordinary skill in the art that with the evolution of system architecture and the emergence of new service scenarios, the technical solutions provided by the embodiment of the present disclosure are also applicable to similar technical problems.

There is a requirement in TS22.261 that a 5th generation mobile communication technology (5G) system with satellite access is ought to support different configurations, in which the radio access network is a satellite NG-RAN or a non-3GPP satellite access network, or both.

However, for a satellite terminal that does not support NR, there is currently no solution for a 3GPP network to serve the satellite terminal that does not support NR.

Embodiments of the present disclosure provide a method and device for accessing a user equipment to a mobile network. A satellite terminal that does not support NR accesses the mobile network through an untrusted or trusted non-3rd generation partnership project (3GPP) access network, so that the mobile network can serve the satellite terminal that does not support NR.

The method and device for accessing a user equipment to a mobile network provided by the present disclosure are described in detail below in conjunction with the accompanying drawings.

Reference is made to FIG. 3, which is a schematic flowchart of a method for accessing a user equipment to a mobile network, provided by an embodiment of the present disclosure. It is to be noted that the method of the embodiment of the present disclosure is performed by the user equipment. As shown in FIG. 3, the method may include, but is not limited to, the following steps.

Step 301, access the user equipment to the mobile network through an untrusted or trusted non-3GPP access network.

In some embodiments of the present disclosure, the user equipment may be a satellite terminal that does not support NR, and the user equipment has satellite access and NAS capabilities.

In one implementation, it is possible to select to access the user equipment to the mobile network through an untrusted or trusted non-3GPP access network according to pre-configured information in the user equipment. In some examples, in some embodiments of the present disclosure, the non-3GPP access network is a satellite access network; the pre-configured information may include combined information of a satellite access and a 5G core network.

That is, for the user equipment accessing the 5G core network in the embodiments of the present disclosure, there are two types of satellite access: trusted and untrusted. These two types may be selected according to pre-configuring the combined information of the satellite access and the 5G core network (such as PLMN ID) in the user equipment.

For example, if the combined information of the satellite access and the 5G core network pre-configured in the user equipment is a first PLMN ID, it is possible to select to access the user equipment to the mobile network through an untrusted non-3GPP access network. For another example, if the combined information of the satellite access and the 5G core network pre-configured in the user equipment is a second PLMN ID, it is possible to select to access the user equipment to the mobile network through a trusted non-3GPP access network.

By implementing the embodiments of the present disclosure, a satellite terminal that does not support NR can access a mobile network through an untrusted or trusted non-3GPP access network, so that the mobile network can serve the satellite terminal that does not support NR.

In some embodiments of the present disclosure, a satellite terminal that does not support NR may access a mobile network through an untrusted non-3GPP access network. In some examples, reference is made to FIG. 4, which is a schematic flowchart of another method for accessing a user equipment to a mobile network, provided by an embodiment of the present disclosure. It is to be noted that the method of the embodiment of the present disclosure is performed by the user equipment. As shown in FIG. 4, the method may include, but is not limited to, the following steps.

Step 401, connect to the untrusted non-3GPP access network based on an authentication procedure.

In some examples, the user equipment connects to an untrusted non-3GPP access network through any appropriate authentication procedure, and is assigned an IP (Internet Protocol) address. For example, a non-3GPP authentication method, such as no authentication (in the case of free WLAN), EAP (Extensible Authentication Protocol) with pre-shared keys, username/password, or the like may be used.

Step 402, select a non-3GPP interworking function (N3IWF) in a 5G public land mobile network (PLMN) in response to determining that the user equipment is to be connected to a 5G core network.

In some examples, when the user equipment is to be connected to the 5G core network, the user equipment may select the N3IWF in the 5G PLMN, as described in clause 6.3.6 of TS 23.501.

Step 403, establish an Internet protocol security (IPsec) tunnel with the selected N3IWF, where the user equipment is authenticated by and attached to the 5G core network during the establishment of the IPsec tunnel.

In some examples, the user equipment may establish an IPsec tunnel with the selected N3IWF, and is authenticated by and attached to the 5G core network during the establishment of the IPsec tunnel, so that the user equipment connected to the untrusted non-3GPP access network accesses the mobile network.

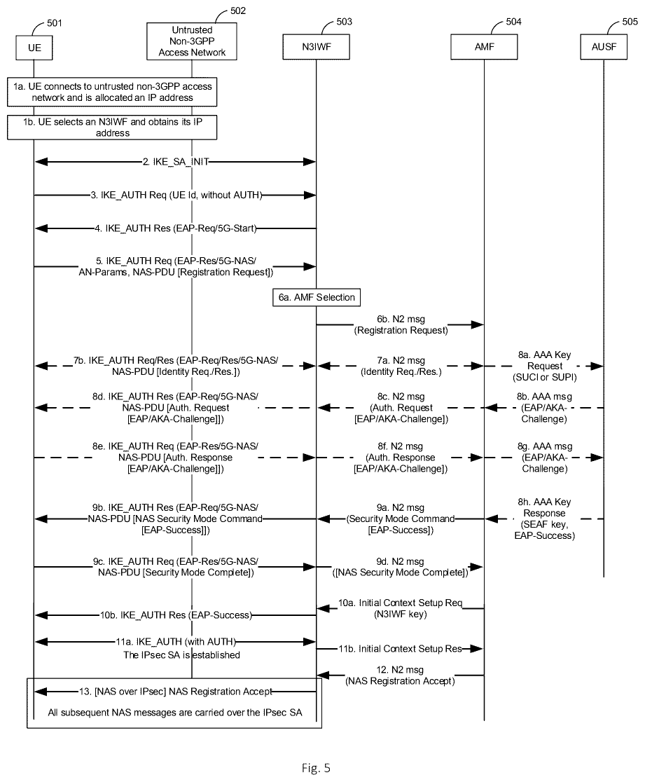

To better understand the method for accessing a user equipment to a mobile network disclosed in an embodiment of the present disclosure, the procedure of registering through an untrusted non-3GPP access network will be described below in conjunction with FIG. 5.

As shown in FIG. 5, in step 1a, the user equipment (UE) 501 connects to an untrusted non-3GPP access network 502 through any appropriate authentication procedure and is assigned an IP address. For example, a non-3GPP authentication method, such as no authentication (in the case of free WLAN), EAP with pre-shared keys, username/password, or the like may be used. In Step 1b, when the UE 501 is to be connected to the 5GC network, the UE 501 selects the N3IWF in the 5G PLMN, as described in clause 6.3.6 of TS 23.501.

In step 2, the UE 501 proceeds to establish, by initiating an IKE (Internet Key Exchange) initial exchange according to RFC 7296, IPsec (Internet Protocol Security) Security Association (SA) with the selected N3IWF. After step 2, all subsequent IKE messages are encrypted and integrity-protected by using the IKE SA established in this step. That is, step 2 corresponds to the IKE SA procedure functioning to establish a secure transmission channel in an incomplete network, ensuring the security of message transmission in the 5G-NAS authentication procedure for the following 5G-NAS authentication procedure. After this step, all IKE messages are encrypted and integrity-protected.

In step 3, the UE 501 is ought to initiate, by sending an IKE_AUTH (Internet Key Exchange Authentication) request message, an IKE_AUTH exchange. The AUTH payload is not included in the IKE_AUTH request message, which indicates that the IKE_AUTH exchange is ought to use EAP signaling (EAP-5G signaling in this case). If the UE 501 supports MOBIKE (Mobility and Multihoming Protocol), the UE 501 is ought to include one Notify payload in the IKE_AUTH request, as specified in RFC 4555, indicating that MOBIKE is supported. In addition, as specified in TS 33.501, if the UE 501 provides the N3IWF 503 root certificate, the UE 501 is ought to include the CERTREQ payload in the IKE_AUTH request message to request the N3IWF 503 certificate.

In step 4, the UE 501 may receive an IKE_AUTH response message sent by the N3IWF 503. In some examples, the N3IWF 503 responds with an IKE_AUTH response message, which includes an EAP-Request/5G-Start packet. The EAP-Request/5G-Start packet informs the UE 501 to initiate an EAP-5G session, i.e., to start sending a NAS message encapsulated in the EAP-5G packet. If the N3IWF 503 has received a CERTREQ payload from the UE 501, the N3IWF 503 is ought to include the CERT payload in the IKE_AUTH response message containing the N3IWF certificate. How the UE 501 uses the N3IWF certificate is specified in TS 33.501.

In step 5, the UE 501 is ought to verify the N3IWF certificate, and confirm that the N3IWF identifier matches the N3IWF selected by the UE 501. If the UE's request for certificate or identity confirmation is unsuccessful, lack of the N3IWF certificate will lead to connection failure. The UE 501 is ought to send an IKE_AUTH request which includes an EAP-Response/5G-NAS packet, the packet containing Access Network parameters (AN parameters) and a registration request message. The AN parameters contain information that is used by the N3IWF 503 for selecting an AMF in the 5G core network. For example, the information may include a GUAMI (Globally Unique Access and Mobility Management Function Identifier), the selected PLMN ID (or PLMN ID and NID, see clause 5.30 of TS23.501), the requested NSSAI (Network Slice Selection Assistance Information, also referred to as identifier of a network slice) and the establishment reason. The establishment reason provides a reason for requesting establishment of a signaling connection with the 5G core network. Whether and how the UE 501 includes the requested NSSAI as part of the AN parameters is dependent on the value of the access stratum connection establishment NSSAI inclusion mode parameter, as specified in section 5.15.9 of TS23.501.

However, the N3IWF 503 does not send an EAP-Identity request because the UE 501 includes its identity in the first IKE_AUTH. This is in line with clause 3.16 of RFC 7296.

In step 6, the N3IWF 503 is ought to select an AMF based on the received AN parameters and local policy, as specified in clause 6.3.5 of TS 23.501. Then the N3IWF 503 is ought to forward the registration request received from the UE 501 to the selected AMF within an N2 message. This message contains N2 parameters that include the selected PLMN ID and the establishment reason. The N3IWF 503 sends an RAT type to the AMF 504 in the N2 message. In some embodiments of the present disclosure, the RAT type may include at least one of:
a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

As one possible implementation, the RAT type may be one of the values shown in Table 1 below:

TABLE 1
Enumeration of RAT Types

| Enumeration value | Description |
|---|---|
| UNTRUSTED_LEO | Untrusted LEO satellite access type |
| UNTRUSTED_MEO | Untrusted MEO satellite access type |
| UNTRUSTED_GEO | Untrusted GEO satellite access type |
| UNTRUSTED_{—} | Untrusted OTHERSAT satellite access type |
| OTHER_SAT | |

It can be understood that each element in the above-mentioned Table 1 exists independently, and these elements are listed in the same table by way of example, but it does not mean that all elements in the table must exist at the same time as shown in the table. The value of each element is independent of the value of any other element in Table 1. Therefore, those skilled in the art can understand that the value of each element in Table 1 is an independent embodiment. It is to be noted that the embodiments of the present disclosure include a plurality of tables, each of which is similar to Table 1 in that a plurality of independent embodiments are combined in the same table, and each element in these tables is ought to also be considered as an independent embodiment.

In Steps 7a and 7b, the selected AMF 504 may request an SUCI (Subscription Concealed Identifier) by sending a NAS Identity Request message to the UE 501. This NAS Identity Request message and all subsequent NAS messages are sent to the UE 501 encapsulated within the EAP/5G-NAS packet.

In step 8 (including steps 8a to 8h), the AMF 504 may authenticate the UE 501 by invoking an AUSF (Authentication Server Function) 505. In this case, the AMF 504 will select an AUSF based on SUPI (Subscription Permanent Identifier) or SUCI, as specified in clause 6.3.4 of TS 23.501. The AUSF 505 executes the authentication of the UE 501 as specified in TS 33.501. The AUSF 505 selects a UDM, as described in section 6.3.8 of TS23.501, and obtains the authentication data from the UDM. The authentication packet is encapsulated in a NAS authentication message encapsulated in an EAP/5G-NAS packet. After a successful authentication, in Step 8h, the AUSF 505 is ought to send to the AMF 504 an anchor key (Secure Anchor Function (SEAF) key) which is used by the AMF 504 to derive the NAS security key and the N3IWF security key (N3IWF key). The UE 501 also derives the anchor key (SEAF key) and derives, from this key, the NAS security key and the N3IWF security key (N3IWF key). The N3IWF key is used by the UE 501 and the N3IWF 503 for establishing the IPsec security association (in step 11).

In step 8h, the AUSF 505 is ought to also include the SUPI if in step 8a the AMF 504 provides SUCI to the AUSF 505.

It is to be noted that EAP-AKA′ or 5G-AKA are allowed for the authentication of the UE 501 via non-3GPP access, as specified in TS33.501. FIG. 5 merely shows an authentication procedure using EAP-AKA′. Authentication methods other than EAP-AKA′ or 5G-AKA are also allowed for the UE 501 accessing SNPN (Stand-alone Non-Public Network) services via a PLMN, as specified in TS33.501, Annex I.

In step 9a, the AMF 504 will send a NAS security mode command message to the UE 501 to activate NAS security. If an EAP-AKA′ authentication is successfully executed in Step 8, the AMF 504 is ought to encapsulate the EAP-Success received from the AUSF 505 in the NAS security mode command message.

In step 9b, the N3IWF 503 is ought to forward the NAS security mode command message to the UE 501 in an EAP/5G-NAS packet.

In step 9c, the UE 501 completes the EAP-AKA′ authentication (if initiated in Step 8), creates a NAS security context and an N3IWF key, and sends the NAS security mode complete message in the EAP/5G-NAS packet.

In step 9d, the N3IWF 503 relays the NAS security mode complete message to the AMF 504.

In step 10a, after receiving the NAS security mode complete, the AMF 504 is ought to send an NGAP (Next Generation Application Protocol) initial context setup request message that contains the N3IWF key.

In step 10b, this will trigger the N3IWF 503 to send an EAP-Success to the UE 501, by which completing the EAP-5G session. EAP-5G packets are no longer exchanged.

In step 11 (including steps 11a and 11b), the IPsec SA is established between the UE 501 and the N3IWF 503 by using a common N3IWF key that is created in the UE 501 in step 9c and received by the N3IWF 503 in Step 10a. This IPsec SA is referred to as the “signaling IPsec SA”. After the establishment of the signaling IPsec SA, the N3IWF 503 informs the AMF 504 to create the UE context (including security) by sending the NGAP initial context setup response message. The signaling IPsec SA is ought to be configured to operate in a tunnel mode and the N3IWF 503 is ought to assign an “inner” IP address to the UE 501. If the N3IWF 503 has received an indication that the UE 501 supports MOBIKE (see step 3), the N3IWF 503 is ought to include a Notify payload in the IKE_AUTH response message sent in Step 11a, indicating that MOBIKE is ought to be supported, as specified in RFC 4555.

All subsequent NAS messages exchanged between the UE 501 and the N3IWF 503 are ought to be sent via the signaling IPsec SA and are ought to be carried over TCP/IP. The UE 501 is ought to send the NAS message within a TCP/IP packet with a source address being the “inner” IP address of the UE 501 and a destination address being the NAS_IP_ADDRESS that is received in step 11a. The N3IWF 503 is ought to send a NAS message in a TCP/IP packet with a source address being the NAS_IP_ADDRESS and a destination address being the “inner” IP address of the UE 501. The TCP connection used for reliable NAS transport between the UE 501 and the N3IWF 503 is ought to be initiated by the UE 501 immediately after the establishment of the signaling IPsec SA in Step 11a. The UE 501 is ought to send the TCP connection request to the NAS_IP_ADDRESS and to the TCP port number specified in TS24.502.

In step 12, the AMF 504 sends a NAS registration accept message to the N3IWF 503. The N2 message includes the allowed NSSAI (Network Slice Selection Assistance Information) for the access type for the UE 501.

In step 13, the N3IWF 503 forwards the NAS registration accept message to the UE 501 via the established signaling IPsec SA. If the N3IWF 503 receives the NAS registration accept message before the establishment of the IPsec SA, the N3IWF 503 is ought to store this NAS registration accept message and forward this NAS registration accept message to the UE 501 merely after the establishment of the signaling IPsec SA.

In some embodiments of the present disclosure, the AMF 504, upon registration with the UDM, provides to the UDM the access type set to “Non-3GPP access” and the RAT type according to the RAT type received in step 6b, or according to a configuration between an untrusted satellite access network and the AMF 504. As an example, for the case where an RAT type is received in Step 6b, when the AMF 504 registers with the UDM, the AMF 504 may provide to the UDM the access type set to “Non-3GPP access” and the RAT type according to the received RAT type. As another example, for the case where an RAT type is not received in Step 6b, when the AMF 504 registers with the UDM, the AMF 504 may provide to the UDM the access type set to “Non-3GPP access” and the RAT type according to a configuration between an untrusted satellite access network and the AMF 504.

In an embodiment of the present disclosure, the RAT type may include at least one of:
a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

As one possible implementation, the RAT type may be one of the values shown in Table 1 above.

By implementing the embodiments of the present disclosure, a satellite terminal that does not support NR can access a mobile network through an untrusted non-3GPP access network, so that the mobile network can serve the satellite terminal that does not support NR.

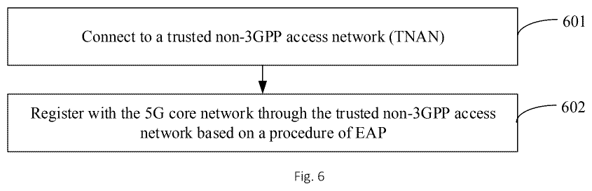

In some embodiments of the present disclosure, a satellite terminal that does not support NR may access a mobile network through a trusted non-3GPP access network. In some examples, reference is made to FIG. 6, which is a schematic flowchart of another method for accessing a user equipment to a mobile network, provided by an embodiment of the present disclosure. It is to be noted that the method of the embodiments of the present disclosure is performed by the user equipment. As shown in FIG. 6, the method may include, but is not limited to, the following steps.

Step 601, connect to a trusted non-3GPP access network (TNAN).

Step 602, register with the 5G core network through the trusted non-3GPP access network based on a procedure of EAP.

In an embodiment of the present disclosure, the link between the user equipment and the trusted non-3GPP access network may be any data link (L2) that supports EAP encapsulation, e.g., PPP (Point-to-Point Protocol), PANA (Protocol for carrying Authentication for Network Access), Ethernet, IEEE (Institute of Electrical and Electronics Engineers) 802.3, IEEE 802.11, and the like.

In an embodiment of the present disclosure, the trusted non-3GPP access network (TNAN) may include a trusted non-3GPP access point (TNAP) and a trusted non-3GPP gateway function (TNGF), and the interface between the trusted non-3GPP access point and the trusted non-3GPP gateway function is an AAA interface. The trusted non-3GPP access point (TNAP) may be a satellite, and the trusted non-3GPP gateway function (TNGF) may be an S-AGF.

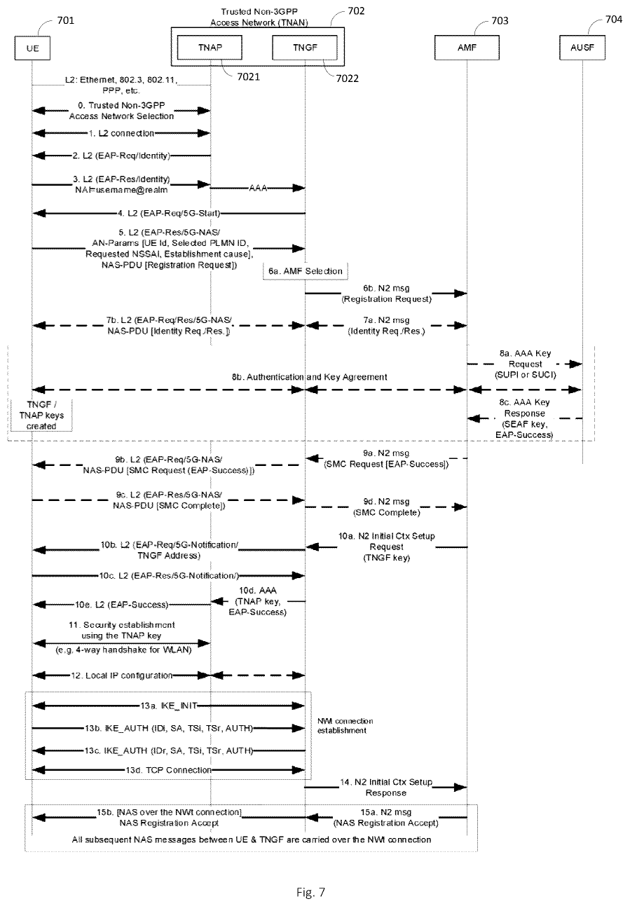

To better understand the method for accessing a user equipment to a mobile network disclosed in an embodiment of the present disclosure, the procedure of registering through a trusted non-3GPP access network will be described below in conjunction with FIG. 7.

As shown in FIG. 7, in step 0, the user equipment (UE) 701 selects, by using the selection procedure of the trusted non-3GPP access network, one PLMN and one TNAN 702 to connect to the PLMN. During this procedure, the UE 701 discovers the PLMNs with which the TNAN 702 supports trusted connectivity (e.g., “5G connectivity”).

In step 1, an L2 (Layer-2) connection is established between the UE 701 and the trusted non-3GPP access point (TNAP) 7021, that is, the L2 connection may be a satellite connection between the UE 701 and a satellite.

In steps 2 to 3, an EAP procedure is initiated. An EAP message is encapsulated into an L2 packet, e.g., into an IEEE 802.3/802.1x packet, into an IEEE 802.11/802.1x packet, into a PPP packet, etc. The NAI (Network Access Identifier) provided by the UE 701 indicates that the UE 701 requests “5G connectivity” to a specific PLMN, for example, NAI=“<any_username>@nai.5gc.mnc<MNC>.mcc<MCC>0.3gppnetwork.org”. This NAI triggers the TNAP 7021 to send an AAA request to a TNGF which operates as an AAA proxy. Between the TNAP 7021 and the TNGF 7022, the EAP packet is encapsulated as an AAA message. The AAA request also includes a TNAP identifier which may be considered as user location information.

In steps 4 to 10, the EAP-5G procedure is executed. The key points for executing the EAP-5G procedure are as follows:

After a successful authentication, a TNGF key is created in the UE 701 and the AMF 703. In step 10a (within the N2 initial context setup request message), the TNGF key is transmitted from the AMF 703 to the TNGF 7022. TNGF 7022 derives one TNAP key which is provided to the TNAP 7021. The TNAP key depends on the non-3GPP access technology (e.g., in the case of IEEE Std 802.11, the TNAP key is a pairwise master key).

In step 5, the UE 701 is ought to include the requested NSSAI in the AN parameters merely if the trusted non-3GPP access is allowed. The UE 701 is ought to also include a UE Id in the AN parameters. For example, the UE Id may be a 5G-GUTI (5th Generation Mobile Communication Technology-Globally Unique Temporary Identifier) if this 5G-GUTI is available from a prior registration to the same PLMN.

It is to be noted that, in an embodiment of the present disclosure, in the N2 message sent in step 6b, the TNGF 7022 includes UE location information (ULI) which includes a “null” IP address (e.g., 0.0.0.0) because the UE 701 has not been assigned an IP address. After the UE 701 is assigned an IP address, the TNGF 7022 includes this IP address in subsequent N2 messages. The TNGF 7022 sends an RAT type to the AMF 703 in an N2 message. In step 8, AUSF (Authentication Server Function) 704 can interacts with AMF 703. In some embodiments of the present disclosure, the RAT type may include at least one of:
an untrusted or trusted low earth orbit (LEO) satellite access type;
an untrusted or trusted medium earth orbit (MEO) satellite access type;
an untrusted or trusted geostationary earth orbit (GEO) satellite access type; or
an untrusted or trusted other satellite (OTHERSAT) satellite access type.

As one possible implementation, the RAT type may be one of the values shown in Table 2 below:

TABLE 2
Enumeration of RAT Types

| Enumeration value | Description |
|---|---|
| TRUSTED_LEO | Trusted LEO satellite access type |
| TRUSTED_MEO | Trusted MEO satellite access type |
| TRUSTED_GEO | Trusted GEO satellite access type |
| TRUSTED_{—} | Trusted OTHERSAT satellite access type |
| OTHER_SAT | |

Notably, after receiving the TNGF key from the AMF 703 in step 10a, the TNGF 7022 is ought to send to the UE 701 an EAP-Request/5G-Notification packet that contains “TNGF Contact Info”, which includes the IP address of the TNGF 7022. In step 10d, after the TNGF 7022 receives an EAP-Response/5G-Notification packet from the UE 701 in Step 10c, the TNGF 7022 is ought to send a message that contains an EAP-Success packet.

In step 11, the TNAP key is used to establish L2 (Layer-2) security between the UE 701 and the TNAP 7021. In the case of IEEE Std 802.11, four handshakes are executed to establish a security context between the satellite and the UE 701 for protecting unicast and multicast traffic over the air.

In step 12, the UE 701 receives IP configuration information from the TNAN (Trusted Non-3GPP Access Network) 702, for example using DHCP (Dynamic Host Configuration Protocol). At this point, the UE 701 has successfully connected to the TNAN 702 and has obtained the IP configuration information.

In step 13 (including steps 13a to 13c), the UE 701 establishes a secure NWt connection with the TNGF 7022. The UE 701 establishes the secure NWt connection with the TNGF 7022 as follows:
the UE 701 initiates an IKE_INIT exchange using the IP address of the TNGF 7022 received during the EAP-5G signaling in step 10b. Subsequently, the UE 701 initiates an IKE_AUTH exchange and provides its identity. The identity provided by the UE 701 in the IKEv2 (IKE version 2) signaling is ought to be the same as the UE Id included in the AN parameters in step 5. This enables the TNGF 7022 to locate the TNGF key that was created before for the UE 701, during the authentication in step 8. The TNGF key is used for mutual authentication. NULL encryption is negotiated between the UE 701 and the TNGF 7022 as specified in RFC 2410.

It is to be noted that, in step 13c, the TNGF 7022 provides to the UE an “inner” IP address, a NAS_IP_ADDRESS and a TCP port number, as well as a DSCP (Differentiated Services Code Point) value. After this step, an IPsec SA is established between the UE 701 and the TNGF 7022. This is referred to as the “signaling IPsec SA” and operates in a tunnel mode. Operation in the tunnel mode enables the use of MOBIKE for re-establishing the IPsec SA when the IP address of the UE 701 changes during a mobility event. All IP packets exchanged between the UE 701 and the TNGF 7022 via the “signaling IPsec SA” is ought to be marked with the above-mentioned DSCP value. The UE 701 and the TNAP 7021 may map the DSCP value to a QoS (Quality of Service) level (e.g., EDCA access class) supported by the underlying non-3GPP access network.

Notably, after the “signaling IPsec SA” is established, the UE 701 will establish a TCP connection with the TNGF 7022 by using the NAS_IP_ADDRESS and the TCP port number received in step 13c. The UE 701 is ought to send a NAS message in a TCP/IP packet with a source address being the “inner” IP address of the UE 701 and a destination address being the NAS_IP_ADDRESS. The TNGF 7022 is ought to send a NAS message in a TCP/IP packet with a source address being the NAS_IP_ADDRESS and a destination address being the “inner” IP address of the UE.

In step 14, after the NWt connection is successfully established, the TNGF 7022 responds to the AMF 703 with an N2 initial context setup response message.

In step 15 (including steps 15a and 15b), the NAS registration sccept message is sent by the AMF 703 and is forwarded to the UE 701 via the established NWt connection. At this time, the UE 701 can use the TNAN 702 to transmit the non-seamless offload traffic and to establish one or more PDU sessions. The AMF 703, upon registration with the UDM, provides to the UDM the access type set to “Non-3GPP access” and the RAT type according to the RAT type received from the TNGF 7022 in Step 6b, or according to a configuration for the trusted satellite access network in the AMF 703. As an example, for the case where an RAT type is received from the TNGF 7022 in step 6b, when the AMF 703 registers with the UDM, the AMF 703 may provide to the UDM the access type set to “Non-3GPP access” and the RAT type according to the received RAT type. As another example, for the case where an RAT type is not received from the TNGF 7022 in step 6b, when the AMF 703 registers with the UDM, the AMF 703 may provide to the UDM the access type set to “Non-3GPP access” and the RAT type according to a configuration for the trusted satellite access network in the AMF 703.

In the embodiments of the present disclosure, the RAT type may include at least one of:
an untrusted or trusted low earth orbit (LEO) satellite access type;
an untrusted or trusted medium earth orbit (MEO) satellite access type;
an untrusted or trusted geostationary earth orbit (GEO) satellite access type; or
an untrusted or trusted other satellite (OTHERSAT) satellite access type.

As one possible implementation, the RAT type may be one of the values shown in Table 2 above.

By implementing the embodiments of the present disclosure, a satellite terminal that does not support NR can be accessed to a mobile network through a trusted non-3GPP access network, so that the mobile network can serve the satellite terminal that does not support NR.

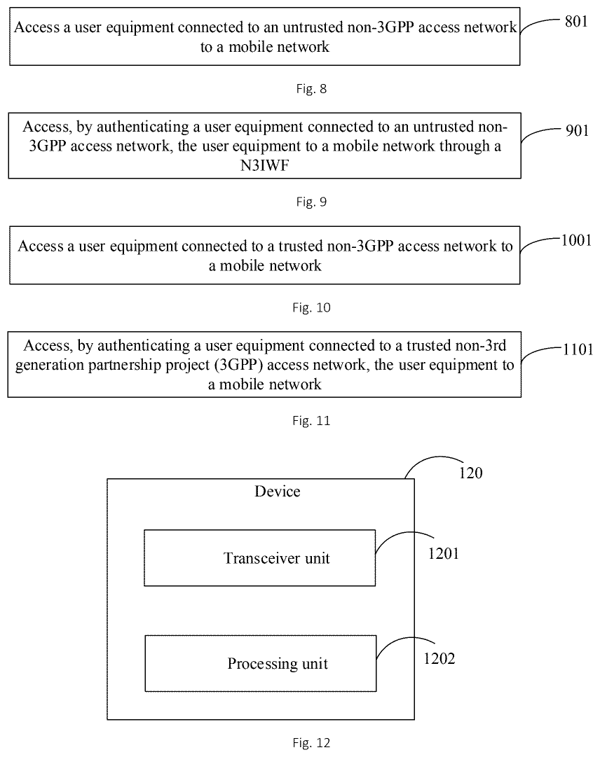

It can be understood that the above-mentioned embodiments describe, from the user equipment side, the implementation of the method for accessing a user equipment to a mobile network in an embodiment of the present disclosure. An embodiment of the present disclosure also provides another method for accessing a user equipment to a mobile network, and the method is to access the user equipment to the mobile network through an untrusted non-3GPP access network. The implementation of the method for accessing the user equipment to the mobile network will be described below from the N3IWF side. Reference is made to FIG. 8, which is a flowchart of yet another method for accessing a user equipment to a mobile network, provided by an embodiment of the present disclosure. It is to be noted that the method for accessing a user equipment to a mobile network in an embodiment of the present disclosure may be performed by the N3IWF, as shown in FIG. 8, and the method may include, but is not limited to, the following steps.

Step 801, access a user equipment connected to an untrusted non-3GPP access network to a mobile network.

In an embodiment of the present disclosure, the user equipment is a satellite terminal that does not support new radio (NR), and the user equipment has satellite access and non-access stratum (NAS) capabilities.

In this technical solution, a user equipment connected to an untrusted non-3GPP access network (a satellite terminal that does not support NR) accesses a mobile network through an N3IWF, so that the mobile network can serve the satellite terminal that does not support NR.

In some embodiments of the present disclosure, the non-3GPP access network is satellite access.

In one implementation, the N3IWF sends an RAT type to the AMF in an N2 message during the access of the user equipment connected to the untrusted non-3GPP access network to the mobile network. In an embodiment of the present disclosure, the RAT type may include at least one of:
a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

In an embodiment of the present disclosure, the N3IWF may access, by interacting with other devices as shown in FIG. 1, the user equipment connected to the untrusted non-3GPP access network to the mobile network. The implementation process can be referred to the implementation of registering through an untrusted non-3GPP access network as shown in FIG. 5, which is not repeated here.

It can be understood that the above-mentioned embodiments describe, respectively from the user equipment and the N3IWF sides, the implementation of the method for accessing a user equipment to a mobile network in an embodiment of the present disclosure. An embodiment of the present disclosure also provides another method for accessing a user equipment to a mobile network, and the method is to access the user equipment to the mobile network through an untrusted non-3GPP access network. The implementation of the method for accessing a user equipment to a mobile network will be described below from the AMF side. Reference is made to FIG. 9, which is a flowchart of yet another method for accessing a user equipment to a mobile network, provided by an embodiment of the present disclosure. It is to be noted that the method for accessing a user equipment to a mobile network in an embodiment of the present disclosure may be performed by the AMF, as shown in FIG. 9, and the method may include, but is not limited to, the following steps.

Step 901, access, by authenticating a user equipment connected to an untrusted non-3GPP access network, the user equipment to a mobile network through a N3IWF.

In the embodiments of the present disclosure, the user equipment is a satellite terminal that does not support new radio (NR), and the user equipment has satellite access and non-access stratum (NAS) capabilities. As one implementation, the access type of the non-3GPP access may be satellite access.

In this technical solution, through authentication, by an AMF, of a user equipment connected to an untrusted Non-3GPP access network (a satellite terminal that does not support NR), the satellite terminal that does not support NR accesses a mobile network through an N3IWF, so that the mobile network can serve the satellite terminal that does not support NR.

In one implementation, the AMF may receive a radio access type (RAT) type sent by the N3IWF in an N2 message.

In one implementation, the AMF provides an access type that is set to Non-3GPP access and a RAT type to a unified data management (UDM) according to a first RAT type when registered with the UDM.

In an embodiment of the present disclosure, the first RAT type is a RAT type received by the AMF; or the first RAT type is a RAT type configured between an untrusted satellite access network and the AMF.

In an embodiment of the present disclosure, the RAT type may include at least one of:
a trusted or untrusted LEO satellite access type;
a trusted or untrusted MEO satellite access type;
a trusted or untrusted GEO satellite access type; or a trusted or untrusted OTHERSAT satellite access type.

As one possible implementation, the RAT type may be one of the values shown in Table 1 above.

In an embodiment of the present disclosure, the AMF may access, by interacting with other devices as shown in FIG. 1, the user equipment connected to the untrusted non-3GPP access network to the mobile network. The implementation process can be referred to the implementation of registering through an untrusted non-3GPP access network as shown in FIG. 5, which is not repeated here.

It can be understood that an embodiment of the present disclosure also provides another method for accessing a user equipment to a mobile network, and the method is to access the user equipment to the mobile network through a trusted non-3GPP access network. The implementation of the method for accessing the user equipment to the mobile network will be described below from the trusted non-3GPP access network (TNAN) side. Reference is made to FIG. 10, which is a flowchart of yet another method for accessing a user equipment to a mobile network, provided by an embodiment of the present disclosure. It is to be noted that the method for accessing a user equipment to a mobile network in an embodiment of the present disclosure may be performed by the trusted non-3GPP access network, as shown in FIG. 10, and the method may include, but is not limited to, the following steps.

Step 1001, access a user equipment connected to a trusted non-3GPP access network to a mobile network.

In an embodiment of the present disclosure, the user equipment is a satellite terminal that does not support new radio (NR), and the user equipment has satellite access and non-access stratum (NAS) capabilities. As an example, the non-3GPP access network is satellite access.

In this technical solution, a satellite terminal that does not support NR accesses a mobile network through a trusted non-3GPP access network, so that the mobile network can serve the satellite terminal that does not support NR.

In some embodiments of the present disclosure, the trusted non-3GPP access network includes a trusted non-3GPP access point and a trusted non-3GPP gateway function, and the interface between the trusted non-3GPP access point and the trusted non-3GPP gateway function is an AAA interface.

In one implementation, the connection between the user equipment and the trusted non-3GPP access point is a satellite connection between the user equipment and a satellite.

In an embodiment of the present disclosure, a radio access type (RAT) type is sent, through the trusted non-3GPP gateway function, to the access and mobility management function (AMF) in an N2 message. In an embodiment of the present disclosure, the RAT type includes at least one of:
an untrusted or trusted LEO satellite access type;
an untrusted or trusted MEO satellite access type;
an untrusted or trusted GEO satellite access type; or
an untrusted or trusted OTHERSAT satellite access type.

As one possible implementation, the RAT type may be one of the values shown in Table 2 above.

In an embodiment of the present disclosure, the trusted non-3GPP access network (TNAN) may access, by interacting with other devices as shown in FIG. 2, the user equipment connected to the trusted non-3GPP access network to the mobile network. The implementation process can be referred to the implementation of registering through a trusted non-3GPP access network as shown in FIG. 7, which is not repeated here.

It can be understood that the above-mentioned embodiments describe, respectively from the user equipment and the trusted non-3GPP access network (TNAN) sides, the implementation of the method for accessing a user equipment to a mobile network in an embodiment of the present disclosure. An embodiment of the present disclosure also provides another method for accessing a user equipment to a mobile network, and the method is to access the user equipment to the mobile network through a trusted non-3GPP access network. The implementation of the method for accessing the user equipment to the mobile network will be described below from the AMF side. Reference is made to FIG. 11, which is a flowchart of yet another method for accessing a user equipment to a mobile network, provided by an embodiment of the present disclosure. It is to be noted that the method for accessing a user equipment to a mobile network in an embodiment of the present disclosure may be performed by the AMF, as shown in FIG. 11, and the method may include, but is not limited to, the following steps.

Step 1101, access, by authenticating a user equipment connected to a trusted non-3rd generation partnership project (3GPP) access network, the user equipment to a mobile network.

In the embodiments of the present disclosure, the user equipment is a satellite terminal that does not support new radio (NR), and the user equipment has satellite access and non-access stratum (NAS) capabilities. As one implementation, the access type of the non-3GPP access is satellite access.

In this technical solution, through authentication, by an AMF, of a user equipment connected to a trusted Non-3GPP access network (a satellite terminal that does not support NR), the satellite terminal that does not support NR accesses a mobile network through an N3IWF, so that the mobile network can serve the satellite terminal that does not support NR.

In some embodiments of the present disclosure, the AMF may receive a radio access type (RAT) type sent by a trusted non-3GPP gateway function in a non-3GPP access network in an N2 message.

In some embodiments of the present disclosure, the AMF may provide an access type that is set to non-3GPP access and a RAT type to a unified data management (UDM) according to a first RAT type when registered with the UDM.

In an embodiment of the present disclosure, the first RAT type is a RAT type received by the AMF; or the first RAT type is a RAT type configured between an untrusted satellite access network and the AMF.

In an embodiment of the present disclosure, the RAT type includes at least one of:
an untrusted or trusted LEO satellite access type;
an untrusted or trusted MEO satellite access type;
an untrusted or trusted GEO satellite access type; or
an untrusted or trusted OTHERSAT satellite access type.

As an example of one possible implementation, the RAT type may be one of the values shown in Table 2 above.

In an embodiment of the present disclosure, the AMF may access, by interacting with other devices as shown in FIG. 2, the user equipment connected to the trusted non-3GPP access network to the mobile network. The implementation process can be referred to the implementation of registering through a trusted non-3GPP access network as shown in FIG. 7, which is not repeated here.

In the above-mentioned embodiments provided by the present disclosure, the method provided by an embodiment of the present disclosure is described respectively from standpoints of the user equipment, the N3IWF, the AMF, and the trusted non-3GPP access network. To implement the various functions in the method provided by the above-mentioned embodiment of the present disclosure, the user equipment, the N3IWF, the AMF, and the trusted non-3GPP access network may include a hardware structure and a software module, and implement the above-mentioned functions in a form of the hardware structure, the software module, or a combination of the hardware structure and the software module. Certain one of the above-mentioned functions may be implemented in the form of the hardware structure, the software module, or a combination of the hardware structure and the software module.

Reference is made to FIG. 12, which is a schematic structural diagram of a device 120 for accessing a user equipment to a mobile network, provided by an embodiment of the present disclosure. The device 120 shown in FIG. 12 may include a transceiver unit 1201 and a processing unit 1202. The transceiver unit 1201 may include a sending unit and/or a receiving unit, the sending unit being configured to implement a sending function, the receiving unit being configured to implement a receiving function. The transceiver unit 1201 may implement a sending function and/or a receiving function.

The device 120 may be a user equipment, or may be a device in the user equipment, or may be a device that can be used in a matching manner with the user equipment. Or the device 120 may be an N3IWF network element, or may be a device in the N3IWF network element, or may be a device that can be used in a matching manner with the N3IWF network element. Or the device 120 may be an AMF network element, or may be a device in the AMF network element, or may be a device that can be used in a matching manner with the AMF network element. Or the device 120 may be a trusted non-3GPP access network, or may be a device in the trusted non-3GPP access network, or may be a device that can be used in a matching manner with the trusted non-3GPP access network.

If the device 120 is a user equipment, in one implementation, the processing unit 1202 is configured to access the user equipment to a mobile network through an untrusted or trusted non-3rd generation partnership project (3GPP) access network. The user equipment is a satellite terminal that does not support new radio (NR), and the user equipment has satellite access and non-access stratum (NAS) capabilities.

In one possible implementation, the user equipment accessing the mobile network by the processing unit 1202 through an untrusted non-3GPP access network may be implemented as follows: connecting to an untrusted non-3GPP access network based on an authentication procedure; selecting a non-3GPP interworking function (N3IWF) in a 5G public land mobile network (PLMN) when the user equipment is to be connected to a 5G core network; establishing an Internet protocol security (IPsec) tunnel with the selected N3IWF, and the user equipment is authenticated by and attached to the 5G core network during the establishment of the IPsec tunnel.

In one possible implementation, the user equipment accessing the mobile network by the processing unit 1202 through a trusted non-3GPP access network may be implemented as follows: connecting to a trusted non-3GPP access network; and registering with a 5G core network through the trusted non-3GPP access network based on a procedure of extensible authentication protocol (EAP), where the link between the user equipment and the trusted non-3GPP access network is a data link that supports EAP encapsulation; the trusted non-3GPP access network includes a trusted non-3GPP access point and a trusted non-3GPP gateway function, and the interface between the trusted non-3GPP access point and the trusted non-3GPP gateway function is an AAA interface.

In one possible implementation, the connection between the user equipment and the trusted non-3GPP access point is a satellite connection between the user equipment and a satellite.

In an embodiment of the present disclosure, the processing unit 1202 may select to access the user equipment to the mobile network through an untrusted or trusted non-3GPP access network according to pre-configured information in the user equipment. As an example, the non-3GPP access network is a satellite access network; the pre-configured information includes combined information of a satellite access and a 5G core network.

In the case of untrusted non-3GPP access, the device 120 is an N3IWF: In one implementation, the processing unit 1202 is configured to access a user equipment connected to an untrusted non-3GPP access network to a mobile network, where the user equipment is a satellite terminal that does not support new radio (NR), and the user equipment has satellite access and non-access stratum (NAS) capabilities. As an example, the non-3GPP access network is satellite access.

In one possible implementation, the processing unit 1202 sends a radio access type (RAT) type to the access and mobility management function (AMF) in an N2 message. In an embodiment of the present disclosure, the RAT type includes at least one of:
a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

In the case of untrusted non-3GPP access, the device 120 is an AMF: In one implementation, the processing unit 1202 is configured to access, by authenticating a user equipment connected to an untrusted non-3rd generation partnership project (3GPP) access network, the user equipment to a mobile network through a non-3GPP interworking function (N3IWF); the user equipment is a satellite terminal that does not support new radio (NR), and the user equipment has satellite access and non-access stratum (NAS) capabilities. As an example, the access type of the non-3GPP access is satellite access.

In one possible implementation, the processing unit 1202 is further configured to receive a radio access type (RAT) type sent by the N3IWF in an N2 message.

In one possible implementation, the processing unit 1202 is further configured to, upon registration with a unified data management (UDM), provide to the UDM the access type that is set to Non-3GPP access and the RAT type according to a first RAT type. In an embodiment of the present disclosure, the first RAT type is the RAT type received by the AMF; or the first RAT type is the RAT type configured between an untrusted satellite access network and the AMF.

In an embodiment of the present disclosure, the RAT type includes at least one of: a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

In the case of trusted non-3GPP access, the device 120 is a trusted non-3GPP access network: In one implementation, the processing unit 1202 is configured to access a user equipment connected to the trusted non-3GPP access network to a mobile network; the user equipment is a satellite terminal that does not support new radio (NR), and the user equipment has satellite access and non-access stratum (NAS) capabilities. As an example, the non-3GPP access network is satellite access.

In one possible implementation, the trusted non-3GPP access network includes a trusted non-3GPP access point and a trusted non-3GPP gateway function, and the interface between the trusted non-3GPP access point and the trusted non-3GPP gateway function is an AAA interface.

In one possible implementation, the connection between the user equipment and the trusted non-3GPP access point is a satellite connection between the user equipment and a satellite.

In one possible implementation, the processing unit 1202 is further configured to send, through the trusted non-3GPP gateway function, a radio access type (RAT) type to the access and mobility management function (AMF) in an N2 message. In an embodiment of the present disclosure, the RAT type includes at least one of:
an untrusted or trusted low earth orbit (LEO) satellite access type;
an untrusted or trusted medium earth orbit (MEO) satellite access type;
an untrusted or trusted geostationary earth orbit (GEO) satellite access type; or
an untrusted or trusted other satellite (OTHERSAT) satellite access type.

In the case of trusted non-3GPP access, the device 120 is an AMF: In one implementation, the processing unit 1202 is configured to access, by authenticating a user equipment connected to a trusted non-3rd generation partnership project (3GPP) access network, the user equipment to a mobile network, where the user equipment is a satellite terminal that does not support new radio (NR), and the user equipment has satellite access and non-access stratum (NAS) capabilities. As an example, the access type of the non-3GPP access is satellite access.

In one possible implementation, the processing unit 1202 is further configured to receive a radio access type (RAT) type sent by a trusted non-3GPP gateway function in a non-3GPP access network in an N2 message.

In one possible implementation, the processing unit 1202 is further configured to, upon registration with a unified data management (UDM), provide an access type that is set to non-3GPP access and a RAT type to a unified data management (UDM) according to a first RAT type when registered with the UDM.

In an embodiment of the present disclosure, the first RAT type is the RAT type received by the AMF; or the first RAT type is the RAT type configured between an untrusted satellite access network and the AMF.

In one possible implementation, the RAT type includes at least one of:
an untrusted or trusted low earth orbit (LEO) satellite access type;
an untrusted or trusted medium earth orbit (MEO) satellite access type;
an untrusted or trusted geostationary earth orbit (GEO) satellite access type; or
an untrusted or trusted other satellite (OTHERSAT) satellite access type.

With respect to the device in the above-mentioned embodiments, the specific manners in which various units perform operations have been described in detail in the embodiments regarding the method, which will not be elaborated here.

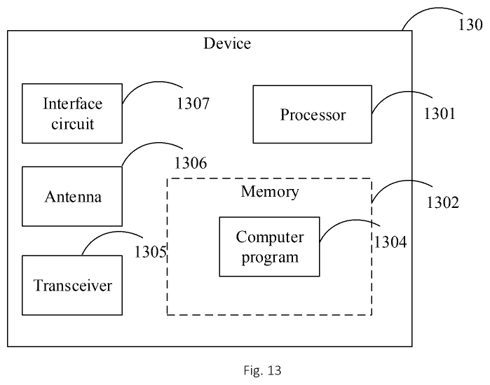

Reference is made to FIG. 13, which is a schematic structural diagram of another device 130 for accessing a user equipment to a mobile network, provided by an embodiment of the present disclosure. The device 130 may be a user equipment, or may be an N3IWF, or may be an AMF, or may be a trusted non-3GPP access network, or may be a chip, chip system, or processor, etc. that supports the user equipment to implement the above-mentioned method, or may be a chip, chip system, or processor, etc. that supports the N3IWF to implement the above-mentioned method, or may be a chip, chip system, or processor, etc. that supports the AMF to implement the above-mentioned method, or may be a chip, chip system, or processor, etc. that supports the trusted non-3GPP access network to implement the above-mentioned method. The device may be configured to implement the method described in the above-mentioned method embodiments. For details, reference can be made to the description in the above-mentioned method embodiments.

The device 130 may include one or more processors 1301. The processor 1301 may be a general-purpose processor or a special-purpose processor, or the like. For example, it may be a baseband processor or a central processing unit. The baseband processor may be configured to process a communication protocol and communication data. The central processing unit may be configured to control a communication device (e.g., a base station, a baseband chip, a terminal device, a terminal device chip, a DU or a CU, etc.), execute a computer program, and process data of the computer program.

In some examples, the device 130 may also include one or more memories 1302 on which a computer program 1304 may be stored. The processor 1301 executes the computer program 1304 to cause the device 130 to perform the method described in the above-mentioned method embodiments. In some examples, data may also be stored in the memory 1302. The device 130 and the memory 1302 may be disposed separately, or integrated together.

In some examples, the device 130 may also include a transceiver 1305 and an antenna 1306. The transceiver 1305 may be referred to as a transceiver unit, a transmitter receiver, a transceiver circuit, or the like, and is configured to implement transceiver functions. The transceiver 1305 may include a receiver and a transmitter. The receiver may be referred to as a receiving machine or a receiving circuit, or the like, and is configured to implement a receiving function; the transmitter may be referred to as a transmitting machine or a transmitting circuit, or the like, and is configured to implement a sending function.

In some examples, one or more interface circuits 1307 may also be included in the device 130. The interface circuit 1307 is configured to receive a code instruction and transmit the code instruction to the processor 1301. The processor 1301 runs the code instruction to cause the device 130 to perform the method described in the above-mentioned method embodiments.

In one implementation, a transceiver configured to implement receiving and sending functions may be included in the processor 1301. For example, the transceiver may be a transceiver circuit, or an interface, or an interface circuit. The transceiver circuit, the interface or the interface circuit configured to implement the receiving and sending functions may be separated, or integrated together. The above-mentioned transceiver circuit, interface or interface circuit may be configured to read and write code/data, or the above-mentioned transceiver circuit, interface or interface circuit may be configured for transmission or transfer of a signal.

In one implementation, the processor 1301 may store a computer program, which runs on the processor 1301 so as to cause the device 130 to perform the method described in the above-mentioned method embodiments. The computer program may be solidified in the processor 1301. In this case, the processor 1301 may be implemented by hardware.

In one implementation, the device 130 may include a circuit, which may implement the function of sending or receiving or communication in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, or the like. The processor and transceiver may also be manufactured by using various IC process technologies, for example, a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs) or the like.

The device described in the above embodiments may be a network device or a terminal device (such as the first terminal device in the foregoing method embodiment), but the scope of the device described in the present disclosure is not limited to this, and the structure of the device may not be limited to FIG. 13. The device may be a stand-alone device or part of a larger device. For example, the device may be:
(1) a stand-alone integrated circuit (IC), or a chip, or a system or sub-system on chips;
(2) a set having one or more ICs, and in some examples, the IC set may also include a storage component configured to store data and a computer program;
(3) an ASIC, such as a modem;
(4) a module that can be embedded into other devices;
(5) a receiving machine, a terminal device, a smart terminal device, a cellular phone, a wireless device, a handheld device, a mobile unit, a vehicle-mounted device, a network device, a cloud device, an artificial intelligence device, or the like;
(6) others.

Those skilled in the art may further understand that various illustrative logical blocks and steps listed in the embodiments of the present disclosure may be implemented by electronic hardware, computer software, or a combination of both. Whether such function is implemented by hardware or software depends on specific applications and the design requirements of the entire system. Those skilled in the art may implement the described function by using a variety of methods for each specific application, but such implementation is not to be construed as exceeding the scope of protection of the embodiments of the present disclosure.

An embodiment of the present disclosure further provides a system for accessing a user equipment to a mobile network. The system includes a device as a user equipment, a device as an N3IWF, and a device as an AMF in the foregoing embodiment of FIG. 12, or the system includes a device as a user equipment, a device as an N3IWF, and a device as an AMF in the foregoing embodiment of FIG. 13.

An embodiment of the present disclosure further provides another system for accessing a user equipment to a mobile network. The system includes a device as a user equipment, a device as a trusted non-3GPP access network, and a device as an AMF in the foregoing embodiment of FIG. 12, or the system includes a device as a user equipment, a device as a trusted non-3GPP access network, and a device as an AMF in the foregoing embodiment of FIG. 13.

An electronic device is further provided according to the present disclosure. The electronic device may be the user equipment, the N3IWF, the AMF and the trusted non-3rd generation partnership project (3GPP) access network provided in the above description, which is not limited in the present disclosure.

The present disclosure further provides a readable storage medium having an instruction stored thereon. The functions in any of the above method embodiments are implemented when the instruction is executed by a computer.

The present disclosure further provides a computer program product. The functions in any of the above method embodiments are implemented when the computer program product is executed by a computer.

In the above-mentioned embodiments, the functions may be implemented in whole or in part by software, hardware, firmware, or any combination of there. When implemented by using software, the functions may be implemented in whole or in part in form of a computer program product. The computer program product includes one or more computer programs. When the computer program is loaded and executed on a computer, the processes or functions described according to the embodiments of the present disclosure are generated in whole or in part. The computer may be a general-purpose computer, a special-purpose computer, a computer network, or another programmable device. The computer program may be stored in a computer-readable storage medium, or transmitted from one computer-readable storage medium to another. For example, the computer program may be transmitted, in a wired (e.g., coaxial cable, optical fiber, digital subscriber line (DSL)) or wireless (e.g., infrared, wireless, microwave, etc.) manner, from one website, computer, server or data center to another website, compute, server or data center. The computer-readable storage medium may be any available medium that a computer can access, or a data storage device, such as a server, a data center, or the like containing one or more available media integrated. The available medium may be a magnetic medium (e.g., a floppy disk, a hard disk and a magnetic tape), an optical medium (e.g., a digital video disc (DVD)), or a semiconductor medium (e.g., a solid state disk (SSD)), or the like.

Those of ordinary skill in the art can understand that the various numerical numbers such as first and second involved in the present disclosure are distinguished merely for the convenience of description, and are not intended to limit the scope of the embodiments of the present disclosure, and also indicate the order of precedence.

The term “at least one” in the present disclosure may also be described as one or more, and “a plurality of” may be two, three, four, or more, which are not limited in the present disclosure. In the embodiments of the present disclosure, technical features of a technical feature are distinguished by “first”, “second”, “third”, “A”, ‘B’, “C”, “D”, etc., and there is no order of precedence or size between the technical features described by the “first”, “second”, “third”, “A”, “B”, “C” and “D”.

The correspondences shown in the various tables in the present disclosure may be configured or may be predefined. The values of the information in the various tables are merely examples, and may be configured as other values, which is not limited in the present disclosure. When configuring a correspondence between the information and various parameters, it is not necessarily to configure all the correspondences shown in the various tables. For example, the correspondences shown in some rows of a table in the present disclosure may not be configured. For another example, appropriate deformation adjustments, e.g., splitting, merging, and the like can be made based on the above-mentioned tables. The names of the parameters shown by the titles in the above-mentioned tables may also adopt other names understandable by the communication device, and the values or representations of the parameters may also be other values or representations understandable by the communication device. When the above-mentioned tables are implemented, other data structures may also be used, for example, an array, a queue, a container, a stack, a linear table, a pointer, a linked list, a tree, a graph, a structural body, a class, a heap, a hash table or hashtable, or the like may be used.

The term “predefined” in the present disclosure may be understood as defined, defined in advance, stored, pre-stored, pre-negotiated, pre-configured, cured, or pre-fired.

Those of ordinary skill in the art may appreciate that the units and algorithm steps of the various examples described in conjunction with the embodiments disclosed herein may be implemented in electronic hardware, or a combination of computer software and electronic hardware. Whether these functions are executed in hardware or software depends on specific applications and design constraints of the technical solution. Professional technicians may implement the described function by using different methods for each particular application, but such implementation is not to be construed as exceeding the scope of the present disclosure.

Those skilled in the art may clearly understand that, for the convenience and brevity of description, the specific working processes of the systems, devices and units described above can refer to the corresponding processes in the aforementioned method embodiments and will not be repeated here.

The above description is merely a specific implementation of the present disclosure, but the scope of protection of the present disclosure is not limited to this. Changes or substitutions that any technician familiar with the technical field may readily conceivable of within the technical scope disclosed in the present disclosure be included in the scope of protection of the present disclosure. Accordingly, the scope of protection of the present disclosure is to be subject to the scope of protection of the claims.

1. A method for accessing a user equipment to a mobile network, performed by the user equipment, the method comprising:
accessing the user equipment to the mobile network through an untrusted or trusted non-3rd generation partnership project (3GPP) access network;
wherein the user equipment is a satellite terminal that does not support new radio (NR), and the user equipment has satellite access and non-access stratum (NAS) capabilities.

2. The method according to claim 1, wherein accessing the user equipment to the mobile network through an untrusted non-3GPP access network comprises:
connecting to the untrusted non-3GPP access network based on an authentication procedure;
selecting a non-3GPP interworking function (N3IWF) in a 5G public land mobile network (PLMN) in response to determining that the user equipment is to be connected to a 5G core network; and
establishing an Internet protocol security (IPsec) tunnel with the selected N3IWF, wherein the user equipment is authenticated by and attached to the 5G core network during the establishing of the IPsec tunnel.

3. The method according to claim 1, wherein accessing the user equipment to the mobile network through a trusted non-3GPP access network comprises:
connecting to the trusted non-3GPP access network; and
registering with a 5G core network through the trusted non-3GPP access network based on a procedure of Extensible Authentication Protocol (EAP);
wherein a link between the user equipment and the trusted non-3GPP access network is a data link that supports EAP encapsulation, the trusted non-3GPP access network comprises a trusted non-3GPP access point and a trusted non-3GPP gateway function, and an interface between the trusted non-3GPP access point and the trusted non-3GPP gateway function is an AAA interface.

4. The method according to claim 3, wherein the connection between the user equipment and the trusted non-3GPP access point is a satellite connection between the user equipment and a satellite.

5. The method according to claim 1, wherein accessing the user equipment to the mobile network through the untrusted or trusted non-3GPP access network comprises:
selecting to access the user equipment to the mobile network through the untrusted or trusted non-3GPP access network according to pre-configured information in the user equipment.

6. The method according to claim 5, wherein the untrusted or trusted non-3GPP access network is a satellite access network; the pre-configured information comprises combined information of the satellite access and a 5G core network.

7-10. (canceled)

11. A method for accessing a user equipment to a mobile network, performed by an access and mobility management function (AMF), the method comprising:
accessing, by authenticating a user equipment connected to an untrusted non-3rd generation partnership project (3GPP) access network, the user equipment to the mobile network through a non-3GPP interworking function (N3IWF); or
accessing, by authenticating a user equipment connected to a trusted non-3GPP access network, the user equipment to the mobile network;
wherein the user equipment is a satellite terminal that does not support new radio (NR), and the user equipment has satellite access and non-access stratum (NAS) capabilities.

12. The method according to claim 11, further comprising:
receiving a radio access type (RAT) type sent by the N3IWF in an N2 message in a case that the user equipment connected to the untrusted non-3GPP access network is authenticated; or
receiving a RAT type sent by a trusted non-3GPP gateway function in the trusted non-3GPP access network in an N2 message in a case that the user equipment connected to the trusted non-3GPP access network is authenticated.

13. The method according to claim 11, further comprising:
providing an access type that is set to Non-3GPP access and a RAT type to a unified data management (UDM), according to a first RAT type when registered with the UDM.

14. The method according to claim 13, wherein the access type of the non-3GPP access is satellite access.

15. The method according to claim 14, wherein:
the first RAT type is a RAT type received by the AMF; or
the first RAT type is a RAT type configured between an untrusted satellite access network and the AMF.

16. The method according to claim 12, wherein the RAT type comprises at least one of the following:
a trusted or untrusted low earth orbit (LEO) satellite access type;
a trusted or untrusted medium earth orbit (MEO) satellite access type;
a trusted or untrusted geostationary earth orbit (GEO) satellite access type; or
a trusted or untrusted other satellite (OTHERSAT) satellite access type.

17. A method for accessing a user equipment to a mobile network, performed by a trusted non-3rd generation partnership project (3GPP) access network, the method comprising:
accessing a user equipment connected to the trusted non-3GPP access network to the mobile network;
wherein the user equipment is a satellite terminal that does not support new radio (NR), and the user equipment has satellite access and non-access stratum (NAS) capabilities.

18. The method according to claim 17, wherein the trusted non-3GPP access network is satellite access.

19. The method according to claim 17, wherein the trusted non-3GPP access network comprises a trusted non-3GPP access point and a trusted non-3GPP gateway function, and an interface between the trusted non-3GPP access point and the trusted non-3GPP gateway function is an AAA interface.

20. The method according to claim 19, wherein the connection between the user equipment and the trusted non-3GPP access point is a satellite connection between the user equipment and a satellite.

21. The method according to claim 19, further comprising:
sending, through the trusted non-3GPP gateway function, a radio access type (RAT) type to an access and mobility management function (AMF) in an N2 message.

22. The method according to claim 21, wherein the RAT type comprises at least one of the following:
an untrusted or trusted low earth orbit (LEO) satellite access type;
an untrusted or trusted medium earth orbit (MEO) satellite access type;
an untrusted or trusted geostationary earth orbit (GEO) satellite access type; or
an untrusted or trusted other satellite (OTHERSAT) satellite access type.

23-28. (canceled)

29. An electronic device, comprising:
one or more processors; and
a memory that stores processor-executable instructions,
wherein the one or more processors are collectively configured to execute the processor-executable instructions to cause the electronic device to act as a user equipment and perform the method according to claim 1.

30. A non-transitory computer-readable storage medium storing instructions, wherein the instructions, when executed by one or more processors, causes the one or more processors to perform the method according to claim 1.
